(19) United States
(12) Patent Application Publication
(10) Pub. No.: US 2014/0236694 A1
(43) Pub. Date: Aug. 21, 2014

(54) SYSTEM AND A METHOD FOR PURCHASING ELECTRONIC VOUCHERS

(71) Applicants: Seng Chuan Tan, Singapore (SG); Meng Lye Sit, Singapore (SG)

(72) Inventors: Seng Chuan Tan, Singapore (SG); Meng Lye Sit, Singapore (SG)

(21) Appl. No.: 14/346,018

(22) PCT Filed: Aug. 16, 2012
(86) PCT No.: PCT/MY12/00234

§ 371 Date: Apr. 10, 2014

(30) Foreign Application Priority Data
Sep. 20, 2011 (MY) PI2011004448

(51) Int. Cl. G06Q 30/02

(52) U.S. Cl. CPC G06Q 30/0222
USPC 705/14.23

(57) ABSTRACT

A system for purchasing electronic vouchers is disclosed. The system comprises a plurality of kiosk terminals (100) for receiving payment made by the users of the system, a group of servers (140-142) for coordinating a purchase transaction and an e-voucher entity (180) for managing and supervising at least one voucher inventory (181,182,183). The kiosk terminals (100) are connected to the group of servers (140-142) in which the group of servers (140-142) establishes a connection with the e-voucher entity (180). The users of the system use the kiosk terminals (100) to purchase the electronic voucher selectable from the voucher inventory (181,182,183) from the e-voucher entity (180) which then sends the electronic voucher as purchased by the users to the users' mobile devices (110) in the form of a text message or a picture message or both.

### FIELD OF INVENTION

The present invention relates to electronic vouchers. More particularly, the present invention relates to a system and a method for purchasing electronic vouchers, storable in and receivable by a mobile device via a kiosk terminal.

### BACKGROUND OF THE INVENTION

Vouchers are documents which are worth a certain monetary value and may be spent for goods or services preferably from a store, merchant or retailer. Examples of vouchers include travel vouchers, food vouchers, service vouchers et cetera. Vouchers are usually purchased beforehand from the store, merchant or retailer such that they may only be used at the place of purchase. Coupons are documents or tickets which may be exchanged for a financial discount or rebate when purchasing goods or services. Coupons are usually issued by the store, merchant or retailer as part of sales promotion. Both the vouchers and coupons are usually distributed in a limited manner and may be printed with a barcode or Quick Response (QR) code which is scan-able by a barcode or QR code reader to entitle the possessor of the vouchers or coupons the monetary value or a discount. Nevertheless, due to the nature of physical vouchers and coupons which are typically manufactured from materials such as paper, they may be susceptible to damage by water or other elements. Additionally, vouchers and coupons which are not kept properly usually get lost or misplaced easily. Physical vouchers also require for the buyer and the seller to be present at the same place in the exchange.

The problems associated with physical vouchers or coupons led to the creation of electronic vouchers and coupons. With the advancement of mobile wireless technology and the convergence of mobile appliances, electronic vouchers and coupons are beginning to gain popular among consumers. Being stored in a mobile device as a text message or a picture message prevents the vouchers and coupons from being physically damaged or from getting lost. Even if the vouchers and coupons are accidentally erased, record remains on database and vouchers or coupons may be easily resent to the users' mobile device by the merchants or retailers.

The usage of electronic vouchers and coupons may also be known as mobile ticketing. Mobile ticketing is a process where consumers may order, pay and obtain electronic tickets, vouchers or coupons and have them sent to the users' mobile devices. Scanners made available by merchants and retailers allow the electronic tickets, vouchers or coupons to be readable at the point of sale or the point of entrance to a ticketed event. This therefore eliminates the need to use paper vouchers and coupons which may be a hassle to keep and maintain. The purchase of electronic vouchers may be done using instructions short messaging service (SMS), but this usually causes 40 percent of the transaction value to be retained by the mobile service provider and SMS aggregator. This high profit margin retained by the mobile service provider prevents the merchants or retailers from offering a better pricing or discount for the purchase of the vouchers or coupons. The Internet, via electronic vouchers and coupons website may also be used for the purchase of the vouchers and coupons but this requires Internet connection and a WAP enabled device. Furthermore, if the users were to purchase the electronic tickets, vouchers or coupons by cash, they would have to do it over the counter which may be a hassle. Additionally, purchase of the electronic tickets, vouchers or coupons cannot be done using a credit card or a debit card via SMS due to the structure of SMS which does not support the security requirement needed of a purchase by credit card.

Among the prior arts related to purchasing electronic vouchers are U.S. Pat. No. 5,039,848 and US patent publication 2004/0124062. Both the US patent and the US patent publication disclosed a machine for dispensing vouchers or coupons upon acceptance of payment by the user. Both the prior art dispenses paper vouchers or coupons. The prior arts did not disclose the purchasing of electronic vouchers via a machine or a kiosk terminal.

Therefore there is a need for a system and a method for purchasing electronic vouchers, storable in and receivable by a mobile device via a kiosk terminal. A voucher is issued from a system and relayed to the buyer via an information network such as the internet or mobile data services and is printed by the buyer at the buyer interface without the seller being physically present is deemed to be an electronic voucher.

### SUMMARY OF INVENTION

Accordingly, it is a primary object of the present invention to provide a system and a method for purchasing electronic vouchers, storable in and receivable by a mobile device via a kiosk terminal.

It is another object of the present invention to provide a system and a method for purchasing electronic vouchers in the form of text messages or picture messages or both.

It is another object of the present invention to provide a plurality of kiosk terminals as point-of-sale terminals for the purchase of electronic vouchers by cash, cards or deduction of mobile airtime credit or mobile wallet points.

It is yet another object of the present invention to provide a system and a method for receiving electronic vouchers via short messaging service (SMS), multimedia messaging service (MMS) or email.

It is further another object of the present invention to provide a system and a method for purchasing electronic vouchers offered by various entities which are storable in mobile devices and interpretable by scanners and readers provided by the various entities.

To fulfil the aforementioned objectives, a system and a method for purchasing electronic vouchers via a plurality of kiosk terminal is utilised. The system comprises a plurality of kiosk terminals connected to a group of servers. The group of servers establishes a connection with an e-voucher entity. The e-voucher entity manages and supervises at least one voucher inventory.

The system may be utilised by users of mobile devices which may include but is not limited to mobile phones, personal digital assistants (PDA), smart phones, tablet computers, laptops, netbooks et cetera. The users of the system use the kiosk terminals to purchase vouchers selectable from the voucher inventory.

The kiosk terminals function in a similar manner as vending machines. The kiosk terminal receives payment made by the users and information such as the users' mobile device number and type. Other information such as account number and/or name may also be requested by the kiosk terminal. Upon receiving payment from the users, the kiosk terminal sends the information to the servers for coordinating the transaction. The servers then send an instruction to the e-voucher entity to send the electronic vouchers as purchased by the users via the kiosk terminal to the users' mobile devices in the form of a text message or a picture message or both. The whole process from payment and receipt of the electronic vouchers by the users may be executed almost instantaneously such that the kiosk terminals are essentially point-of-sale terminals, where transactions are completed.

The present preferred embodiments of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

These and other features, aspects and advantages of the present invention will be more fully understood when considered with respect to the following detailed descriptions, appended claims and accompanying drawings wherein:

FIG. 1 shows a diagram depicting a system for purchasing an electronic voucher or coupon; and

FIG. 2 is a flow chart illustrating a method for purchasing an electronic voucher.

### DETAILED DESCRIPTION OF THE INVENTION

Hereinafter, the present invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

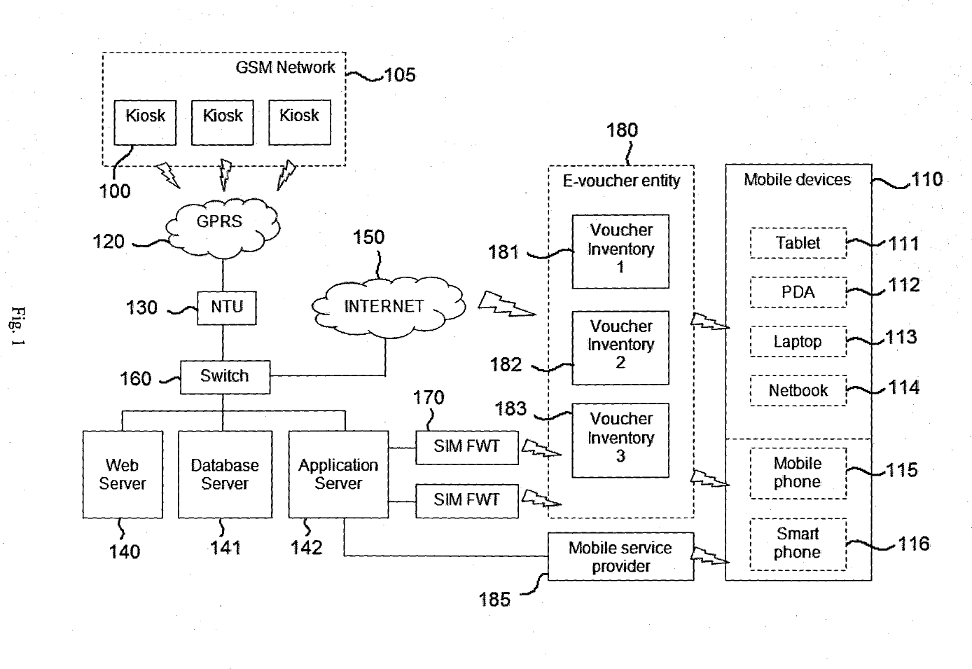

Referring now to FIG. 1, there is shown a diagram depicting a system for purchasing an electronic voucher or coupon, wherein the electronic voucher or coupon is storable in and receivable by a mobile device (110) via a kiosk terminal. The terms voucher and coupon are used interchangeably in the description of the present invention. Electronic voucher may also be referred to as e-voucher. It should be noted that vouchers or coupons may be used as means of payment or representation of a discount or a rebate. The vouchers or coupons may be used as a substitute for cash. The vouchers or coupons may be used as group discount vouchers for group discounts of certain goods or services. They may also be used to entitle the possessor of the vouchers or coupons of a certain monetary benefit or rewards such as loyalty rewards. It should also be appreciated that the term electronic vouchers may include electronic tickets such as airplane tickets, concert tickets, mass transit tickets or tickets for events such as sporting events or concerts.

The system in FIG. 1 comprises a plurality of kiosk terminals (100) connected to a group of servers (140-142). The group of servers (140-142) establishes a connection with an e-voucher entity (180). The e-voucher entity (180) manages and supervises at least one voucher inventory (181,182,183). The system may further comprise at least one mobile service provider (185). The system may be utilised by users of mobile devices (110) which may include but is not limited to mobile phones (115), personal digital assistants (PDA) (112), smart phones (116), tablet computers (111), laptops (113), netbooks (114) et cetera. The users of the system use the kiosk terminals (100) to purchase vouchers selectable from the voucher inventory (181,182,183). The kiosk terminals (100) function in a similar manner as vending machines. The kiosk terminal (100) receives payment made by the users and information such as the users' mobile device number and type. Other information such as account number and/or name may also be requested by the kiosk terminal (100). Upon receiving payment from the users, the kiosk terminal (100) sends the information to the servers (140-142) for coordinating the transaction. The servers (140-142) then send an instruction to the e-voucher entity (180) to send the electronic vouchers as purchased by the users via the kiosk terminal (100) to the users' mobile devices (110) in the form of a text message or a picture message or both. The whole process from payment and receipt of the electronic vouchers by the users may be executed almost instantaneously such that the kiosk terminals (100) essentially are point-of-sale terminals, where transactions are completed.

Still referring to FIG. 1, the plurality of kiosks may be connected to each other through a wired or a wireless connection which forms a network (105). Depending on the distance between each kiosk terminal (100), the network (105) may be local area network (LAN) or a wide area network (WAN). The network (105) may serve to inform the users of the availability of other kiosk terminal (105) within the vicinity in the instance where the current kiosk terminal (100) is down or inoperative. In a preferred embodiment, the kiosk terminals (100) are connected to each other wirelessly via a Global System for Mobile Communications (GSM) network.

The connection between the kiosk terminals (100) and the group of servers (140-142) is established by first having the network (105) linked to a network termination unit (NTU) (130). The link between the network (105) and the NTU (130) may be established through a wired or wireless connection. In a preferred embodiment, the network (110) is wirelessly linked to NTU (130) via a wireless protocol cloud (120). Preferably, the wireless protocol cloud is a GPRS cloud. It should be obvious to a person skilled in the art that the GPRS cloud (120) may be substituted with other wireless protocols and standards such as Code division multiple access (CDMA) and its derivatives, Enhanced Data Rates for GSM Evolution (EDGE), 3G, High Speed Packet Access (HSPA), 3GPP Long Term Evolution (LTE) and the like, in accordance to the advancement of wireless technology with time. The NTU (130) is further connected to a network switch (160). The network switch (160) allows the network (105) of the kiosk terminals (100) to be connected to the group of servers (140-142) or to an Internet cloud (150) or both.

The group of servers (140-142) may include a web server (140), a database server (141) and an application server (142). The information selected and keyed in by the users via the kiosk terminals (100) are stored in the database server (141). The application server (142) coordinates the transaction between the users and the e-voucher entity (180). The web server (140) may run an e-voucher entity's website.

The information selected and keyed in by the users via the kiosk terminals (100) may be sent from the group of servers (140-142) to the e-voucher entity (180) via a plurality of fixed wireless terminal (FWT) (170) which functions to establish a secured wireless connection between the group of servers (140-142) and the e-voucher entity (180). In a preferred embodiment, the wireless connection is a secured GSM link. It should be recognised by a person skilled in the art that the group of servers (140-142) may be linked to the e-voucher entity (180) via a secured wired connection as well.

Alternatively, the information selected and keyed in by the users via the kiosk terminals (100) may be sent to the e-voucher entity (180) via the Internet cloud (150) through a secured wired connection or secured wireless protocol.

In a preferred embodiment of the invention, the e-voucher entity (180) may be an organisation, institution or company which manages and supervises electronic vouchers purchased by the users. The e-voucher entity (180) manages and supervises the voucher inventory (181,182,183). Each voucher inventory (181,182,183) comprises a list of electronic vouchers, which may be cash vouchers or discount coupons preferably provided by a particular entity which may include but is not limited to merchants, vendors, stores, organisations, institutions and/or retailers. The e-voucher entity (180) is therefore in business agreement or affiliated with these entities. The e-voucher entity (180) converts the vouchers and coupons provided by these entities into a form of electronic vouchers. The entities providing the vouchers typically offer the sale of goods or services. For example, a ticketing agent who sells tickets to events and concerts may sell tickets of various mediums such as physical tickets or printable online tickets. Electronic vouchers are therefore another form of tickets purchasable and usable by the users. The electronic vouchers can be showed as tickets at cinemas to gain entry for watching movies. The vouchers or coupons may be used at desktops of stores. Another example would be the purchasing of goods from a merchant. The electronic vouchers can be used in retail outlets for purchasing goods or services. In the instance where the users want to avoid having to carry cash, the users may opt to purchase electronic vouchers via the kiosk terminal (100) to be used when shopping for goods. The usage of vouchers as a substitute for cash may be complemented by rebates and discounts. Furthermore, the vouchers can be used as a deposit for booking products and new products releases. The vouchers also can be used for online purchasing goods or services with dynamic pricing based on real-time market supply and demand. The vouchers also can be provided with location based services support in mobile devices which able to identify the location of products seller or services provider through mobile devices of the user. The vouchers also can be provided with purchases tracking support in mobile devices allowing users to keep track of all their purchased deals in one spot.

The kiosk terminal (100) may be a cash acceptance terminal. In a preferred embodiment, the kiosk terminal (100) is an interactive self-service kiosk. The kiosk terminal may be strategically placed at shopping complexes, malls, merchants' stores, cinemas, mass transit stations et cetera where they may be made conveniently accessible to the users. The kiosk terminal (100) is provided with a notes and coins acceptor unit for receiving notes and coins as means of payment. Notes and coins deposited by the users are stored in a hopper which is securely locked inside the kiosk terminal (100). In order to collect the notes and coins, the kiosk terminal (100) would need to be unlocked by a unique unlocking mechanism. The hopper would then be removed and notes and coins are transferred to a secured storage before being transported.

The kiosk terminal (100) is also provided with a plurality of buttons to allow the users to operate the program installed in the kiosk terminal (100). A screen is built into the kiosk terminal to display the interface of the program. Alternatively, the buttons are not required if a touch screen is provided. Using the buttons and the screen, the user selects and keys in the information requested by the kiosk terminal (100) during the purchase of the electronic voucher. Information requested by the kiosk terminal (100) may include but is not limited to a preferred language of the interface, the name of the voucher to be purchased, the entity offering the voucher, the type of mobile device (110) used to receive the electronic voucher, a mobile phone number (if a mobile phone is used), the value of electronic voucher to be purchase, the name of the user, a Personal Identification Number (PIN), an account number et cetera. The users may select and/or key in a preferred option by hitting the corresponding buttons based on the options displayed and the answer space provided on the screen. The operation of the kiosk terminal (100) is similar to that of an Automatic Teller Machine (ATM), a payphone or a digital vending machine. In yet another preferred embodiment, the kiosk terminal (100) may be provided with speakers and microphones for voice and audio interactions between the users and the kiosk terminal (100).

In another preferred embodiment, the kiosk terminal (100) may accept other modes of payment besides notes and coins. The kiosk terminal (100) may be further provided with a card reader and sensor for detecting payment using cards with security chip or magnetic stripe which include reward cards, points cards, stored-value cards, credit cards or debit cards. The kiosk terminal (100) may also further be provided with a near field communication (NFC) reader which allows the kiosk terminal (100) to establish a connection between itself and mobile devices (110) embedded with NFC chips. NFC allows the kiosk terminal (100) to directly deduct mobile airtime credit or mobile wallet points from the mobile device (110) to be used as a means of payment for the electronic voucher purchased. It should be noted that the mode of payment is not limited to the aforementioned examples and may be varied and improved in accordance to the progression of payment technology in the future.

As mentioned, purchasing of the electronic vouchers using other modes of payment aside from cash may be achieved using the mobile airtime or mobile wallet. In the case where mobile airtime is used as a mode of payment, the e-voucher entity (180) is further affiliated to at least one mobile service provider (185). Once the information requested by the kiosk terminal (100) is selected and keyed in by the user, and sent to the group of servers (140-142), the group of servers (140-142) would send instructions to the e-voucher entity (180) to send the electronic voucher to the user and would send instructions to the mobile service provider (185) to deduct an equivalent value of mobile airtime from the user's mobile device (110) account. A deduction is made to the mobile device (110) account if the user uses a pre-paid account. Otherwise, payment is charged to the users in recurring mobile device package billings.

In the case where mobile wallet points are used as a mode of payment, the e-voucher entity (180) may be affiliated with a mobile wallet provider or the e-voucher entity (180) may itself provide a mobile wallet service to the users. By using the mobile wallet, users may have a separate account from the airtime account. Payment may be made to the mobile wallet providers to top-up the mobile wallet monetary value. A mobile wallet application installed in the mobile device (110) is preferably utilised to allow the users to keep track of the balance and may even allow the users to check on the purchase history.

In another preferred embodiment, the chip card reader, sensor and NFC reader built into the kiosk terminal (100) may also be used to verify the identity of the users. The identity of the user may be verified by having the chip card reader, sensor and/or NFC reader to scan the identity card and/or the mobile device (110). This avoids wrongful usage of the mobile device (110) to purchase electronic vouchers by another person in the instance such as when the mobile device (110) is stolen or taken away from the user. Additionally, identification of the users may also be determined by biometric means wherein the kiosk terminal (100) would be installed with fingerprint readers, retina scans, cameras and/or face recognition software.

In yet another preferred embodiment, the kiosk terminal (100) is provided with a printing means for printing the receipt of the purchase or optionally printing a usable physical copy of the voucher.

The electronic vouchers purchased by the users may be arranged and stored in the mobile device (110) via a dedicated electronic voucher application installed in the mobile device (110). The electronic voucher provided by the e-voucher entity (180) may vary depending on the type of mobile device (110) used by the users. The electronic voucher may be in the form of a text message, picture message or both. The electronic voucher may also be in a digital format supportable by a wireless application protocol (WAP).

In the instance where the electronic voucher is purchased for a mobile device (110) which does not support picture messages, which is typically the case for conventional mobile phones, the electronic voucher is sent to the user in the form of a text message. The text message is sent to the mobile devices (110) via Short Messaging Service (SMS). An alphanumeric code which is a serial number representing the confirmation of purchase or the electronic voucher itself is sent to the user. The user may present this alphanumeric code to the corresponding merchants or stores who keys in the code into their system and verifies the electronic voucher to be used.

In the instance where the electronic voucher is purchased for a mobile device (110) which supports picture messages or WAP, which is usually the case for tablets and smart phones, the electronic voucher may be sent to the user in the form of a text message or picture message or both. The preferable electronic vouchers for these devices are picture messages. Picture messages are sent to the mobile devices (110) via Multimedia Messaging Service (MMS). Electronic voucher is sent in a picture format with a scan-able barcode or QR code. It may also be accompanied with a alphanumeric code. The barcode or QR code is unique to each electronic voucher type and may be used in replacement of a physical paper voucher with a barcode or QR code printed on it. Therefore, instead of having to print the electronic voucher, users of mobile devices (110) which support picture messages or WAP may display the electronic voucher's barcode or QR code on the display screen of the mobile devices (110) and the barcode or QR code may be scanned by a barcode or QR code reader used by participating merchants or stores.

In yet another preferred embodiment, the electronic voucher may be used for online purchasing of products which may range from digital products such as music, movies or electronic books and physical products. The electronic voucher may be used to be uploaded or keyed in on the merchants' or stores' website to be used for online purchasing. The electronic voucher may be used by users who do not have credit or debit cards or users who want to buy items on the internet but do not want to reveal credit/debit card details in certain websites. Furthermore, the electronic voucher may be used by users who do not want exposure to possible additional charges after an internet purchase or users who do not want to use a bank card for an internet purchase or transaction. Electronic voucher may also be used by users who want to purchase a one-time voucher of a fixed amount for purchase of a specific item available at a specific website.

Also preferably, the electronic vouchers may be sent to the mobile devices (110) which support WAP via email in addition to SMS and MMS.

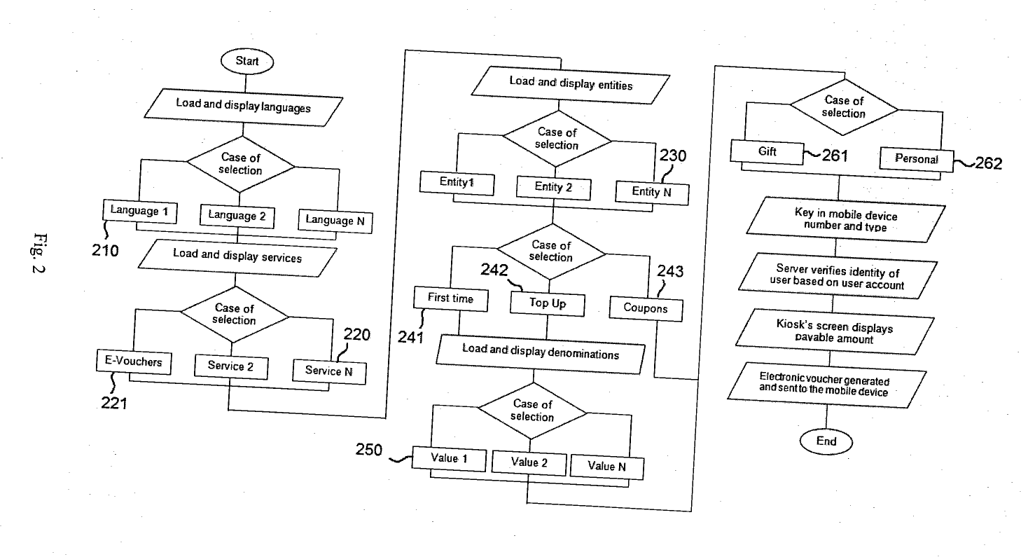

Referring now to FIG. 2, there is shown a flow chart illustrating a method for purchasing an electronic voucher, storable in and receivable by a mobile device (110) via a kiosk terminal (100). The flow chart illustrates the steps needed to be taken by the user in order to purchase the electronic voucher. The steps are in accordance to the sequence of the program installed in the kiosk terminal (100). The users carry out the following steps by selecting and keying in information displayed on the interface of the program on a display screen built into the kiosk terminal (100).

The user first selects a preferred language (210) to be used throughout the duration of the transaction. Upon selection of the preferred language, the interface presents a list of services (220) which may be provided via the kiosk terminal (100). The user selects the e-voucher services (221) option and is then guided to an interface which presents a list of entities (230) to the users. The entities (230) offer electronic voucher services to the users and may be but are not limited to merchants, vendors, stores, organisations, institutions and/or retailers. Upon selecting the corresponding entity, the user may be given the option to select a first time payment of an electronic voucher (241), a topping-up of an electronic voucher (242) or a coupon or ticket purchase (243). These selections depend on the services provided by the entity selected earlier. If the user selects the first time payment of the voucher (241) or a topping-up of the voucher (242), the interface guides the user to select a denomination or a value (250) of the voucher desired to be purchased by the user. Alternatively, the user may key in arbitrary desired value. If the user selects the purchasing of a coupon or ticket, the interface jumps to the following interface.

Once the value of purchase has been keyed in or selected, the user is given an option to purchase the voucher or coupon as a gift (261) or for personal use (262). If the voucher is purchased as a gift (261), the kiosk terminal (100) may additionally instruct the e-voucher entity (180) to label the coupon or voucher as a gift certificate.

The user then proceeds to key in a mobile device (110) number and the mobile device (110) type as requested by the program of the kiosk terminal (100). The mobile device number may be of the users' or of a recipient's of the gift (261) from the user. The kiosk terminal (100) program may also request the user to key in personal information such as account number or name. The user may open an account with the e-voucher entity (180) to track the electronic vouchers purchased. The kiosk terminal (100) program may also request biometric identification verification to avoid wrongful purchases in the instance that the mobile device (110) is stolen.

Once the information has been provided to the kiosk terminal (100), the identity of the user may be verified with the database server (141) based on the user's account information. The kiosk terminal (100) then displays the payable amount via the screen in which the user provides the payment to the kiosk terminal (100). Payment may be made by cash, cards or deduction of mobile airtime credits or mobile wallet points. The kiosk terminal (100) redisplays the payment provided to be confirmed by the user. Upon confirmation, the kiosk terminal (100) sends all input information to the group of servers (140-142) which instruct the e-voucher entity (180) to generate an electronic voucher to be sent to the mobile devices (110) via SMS, MMS and/or email. The kiosk terminal (100) may also optionally print a receipt and a hardcopy of the voucher to be kept by the user. The generation and sending of the electronic voucher is done almost instantaneously after payment is received from the user.

Although this disclosure has described and illustrated certain preferred embodiments of the invention, it is to be understood that the invention is not restricted to those particular embodiments. Rather, the inventions include all embodiments which are functional or mechanical equivalence of the specific embodiments and features that have been described and illustrated.

1-24. (canceled)

25. A system for purchasing an electronic voucher, comprising:
a group of servers for coordinating a purchase transaction;
an e-voucher entity connected to the servers for managing and supervising at least one voucher inventory; and
a plurality of kiosk terminals that are connected to the group of servers for receiving payment from users of the system in the mode of cash, credit or debit card, mobile wallet and/or mobile airtime credit;
whereby the servers verifies identity of user through the user's mobile device number, the servers then allows the user to purchase e-voucher from the voucher inventory through the kiosk terminals, and upon receiving payment from the user, the servers communicates with the e-voucher entity to generate e-voucher to be sent to the user's mobile device in the form of a text message or a picture message or enable the e-voucher to be printed onto a paper voucher at the kiosk terminal.

26. The system according to claim 25, wherein the plurality of kiosk terminals is connected to each other through a wired or wireless connection to form a network.

27. The system according to claim 26, wherein the plurality of kiosk terminals are connected to the group of servers by having the kiosk terminal network linked to a network termination unit (NTU) via a wireless protocol cloud and then to a network switch.

28. The system according to claim 27, wherein the network switch connects the kiosk terminals network to the group of servers or to an Internet cloud or both.

29. The system according to claim 25, wherein the group of servers comprises:
a web server for running an e-voucher entity's website;
a database server for storing the information selected and keyed in by the users via the kiosk terminals; and
an application server for coordinating the transaction between the users and the e-voucher entity.

30. The system according to claim 29, wherein the information selected and keyed in by the users via the kiosk terminals are sent from the group of servers to the e-voucher entity via a plurality of fixed wireless terminal (FWT) which functions to establish a secured wireless connection between the group of servers and the e-voucher entity.

31. The system according to claim 29, wherein the information selected and keyed in by the users via the kiosk terminals are sent to the e-voucher entity via an Internet cloud through a secured wired connection or secured wireless protocol.

32. The system according to claim 25, wherein each voucher inventory comprises a list of electronic vouchers provided by a particular entity which are merchants, vendors, stores, organisations, institutions and/or retailers.

33. The system according to claim 32, wherein the e-voucher entity converts the vouchers and coupons provided by the entities into a form of electronic vouchers.

34. The system according to claim 25, wherein the kiosk terminal is a cash acceptance terminal in the form of an interactive self-service kiosk.

35. The system according to claim 25, wherein the kiosk terminal is provided with a notes and coins acceptor unit for receiving notes and coins as means of payment.

36. The system according to claim 25, wherein the kiosk terminal is provided with a card reader and sensor for detecting payment using cards with security chip or magnetic stripe.

37. The system according to claim 25, wherein the kiosk terminal is provided with a near field communication (NFC) reader which allows the kiosk terminal to establish a connection between itself and mobile devices which are embedded with NFC chips such that the kiosk terminal directly deducts mobile airtime credit or mobile wallet points from the mobile device to be used as a means of payment.

38. The system according to claim 25, wherein the e-voucher entity is affiliated to at least one mobile service provider when mobile airtime is used as a mode of payment.

39. The system according to claim 38, wherein the group of servers sends instructions to the mobile service provider to deduct an equivalent value of mobile airtime from the user's mobile device account or to charge the users.

40. The system according to claim 25, wherein the kiosk terminal is built in with a chip card reader, sensor and NFC reader to verify the identity of the users by scanning the users' identity card and/or mobile device.

41. The system according to claim 25, wherein the kiosk terminal is provided with a printing means for printing receipt of the purchase or a usable physical copy of the voucher.

42. The system according to claim 25, wherein the electronic voucher is sent to the mobile devices via Short Messaging Services (SMS) or Multimedia Messaging Services (MMS) or email.

43. The system according to claim 25, wherein the text message comprises an alphanumeric code which is a serial number representing the confirmation of purchase of the electronic voucher itself.

44. The system according to claim 25, wherein the picture message comprises a scan-able barcode or QR code.

45. The method for purchasing an electronic voucher via an interface of a program installed in a kiosk terminal of claim 25, further comprising the steps of:
selecting an e-voucher services option;
selecting a corresponding entity which include merchants, vendors, stores, organisations, institutions and/or retailers;
selecting the options of a first payment of an electronic voucher or topping-up of an electronic voucher;
selecting or keying in a denomination or a value of the voucher desired to be purchased;
keying in a mobile device number and mobile device type;
making a payment by cash, cards or deduction of mobile airtime credits or mobile wallet points for the electronic voucher purchased; and
receiving an electronic voucher via SMS, MMS and/or email sent by the e-voucher entity to the mobile devices.

46. The method according to claim 45, further comprising the step of providing personal information to the kiosk terminal to verify the identity of the user.

47. The method according to claim 45, further comprising the step of selecting the option of a coupon or ticket purchase.

48. The method according to claim 45, further comprising the step of selecting a preferred language.
